(19) United States
(12) Patent Application Publication
(10) Pub. No.: US 2011/0079998 A1
(43) Pub. Date: Apr. 7, 2011

(54) Coupling for hydraulic disc brake of bicycle

(76) Inventor: Szu-Fang Tsai, Changhua (TW)

(21) Appl. No.: 12/573,888

(22) Filed: Oct. 6, 2009

(51) Int. Cl. F16L 35/00

(52) U.S. Cl. 285/24

(57) ABSTRACT

A coupling for bicycle hydraulic disc brake includes, in combination a housing comprising a stepped-diameter channel having a threaded opening, and a hollow, staged cylindrical member having an inner end disposed at an innermost shoulder of the channel; a hollow cylindrical element formed of metal and comprising an annular groove on an outer surface, and two annular shoulders with the groove formed therebetween wherein the cylindrical element has an inner end disposed at a shoulder adjacent to the innermost shoulder of the channel; a hollow adjustment screw adapted to secure to the threaded opening; and a brake fluid tube slidably disposed through the adjustment screw and the cylindrical element. Driving the adjustment screw will compress the cylindrical element with the groove being completely compressed by the shoulders, the channel being not compressed by the cylindrical element, and the tube being in contact with the cylindrical element.

### BACKGROUND OF THE INVENTION

1. Field of Invention

The invention relates to hydraulic disc brakes of bicycle and more particularly to a coupling for a hydraulic disc brake of a bicycle with improved characteristics including ease of removal of brake fluid tube.

2. Description of Related Art

In recent years, a disc brake apparatus has come into wide use as a bicycle (e.g., mountain bicycle (MTB)) brake. If a brake system with very strong braking force in wet and dry conditions is desired, a disc brake system is typically utilized. Disc brake systems provide a substantial braking power in relationship to the amount of braking force applied to a brake lever. Also, disc brake systems typically provide a high level of consistency in all types of weather and riding conditions.

Disc brakes can be hydraulically or mechanically actuated. Hydraulic disc brake systems provide excellent performance. However, such systems are relatively complicated in construction and expensive to manufacture. Moreover, hydraulic disc brake systems are relatively heavy. In addition, a removal of a broken brake fluid tube from a hydraulic disc brake system for replacement or repair is not easy due to jam. Thus, a need for improvement exists.

### SUMMARY OF THE INVENTION

It is therefore one object of the invention to provide a coupling for a hydraulic disc brake of a bicycle having a characteristic of easy removal of a brake fluid tube.

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of coupling for bicycle hydraulic disc brake according to the invention;

FIG. 2 is a longitudinal sectional view of the assembled coupling; and

FIG. 3 is a view similar to FIG. 2 showing another configuration of the coupling in an installed state.

### DETAILED DESCRIPTION OF THE INVENTION

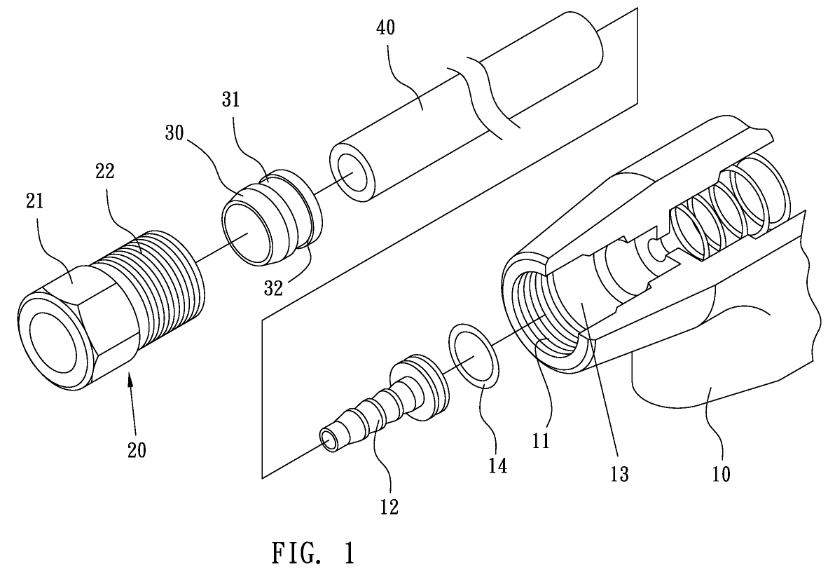

Referring to FIGS. 1 to 3, a coupling for a hydraulic disc brake of a bicycle in accordance with a preferred embodiment of the invention comprises the following components as discussed in detail below.

A housing 10 is formed at a joining portion of a handlebar (not shown) and a brake lever (not shown) of a bicycle (e.g., MTB). The housing 10 comprises a stepped-diameter channel 13 having a threaded opening 11, a hollow, staged cylindrical member 12 having an inner end disposed at an innermost shoulder of the channel 13, and an “O” ring 14 put on a groove (not numbered) at the inner end of the staged cylindrical member 12. A helical spring (not numbered) is mounted in a cylindrical reservoir 15 being in communication with the channel 13.

A hollow cylindrical element 30 is formed of metal (e.g., bronze) and comprises, on its outer surface, an annular groove 31 and two annular shoulders 32 with the groove 31 formed therebetween. The cylindrical element 30 has an inner end disposed at a shoulder adjacent to the innermost shoulder of the channel 13.

A hollow adjustment screw 20 comprises an enlarged head 21 and an externally threaded shank 22. The adjustment screw 20 can be driven to secure to the threaded opening 11.

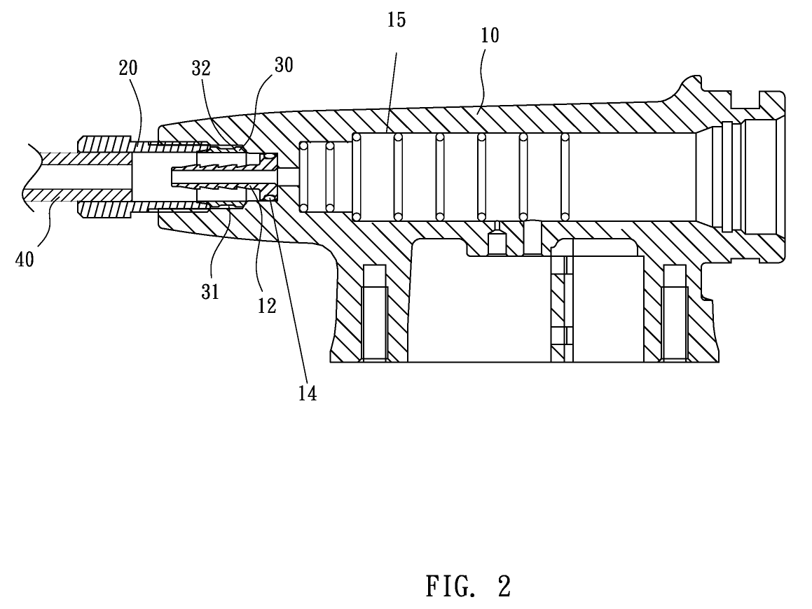

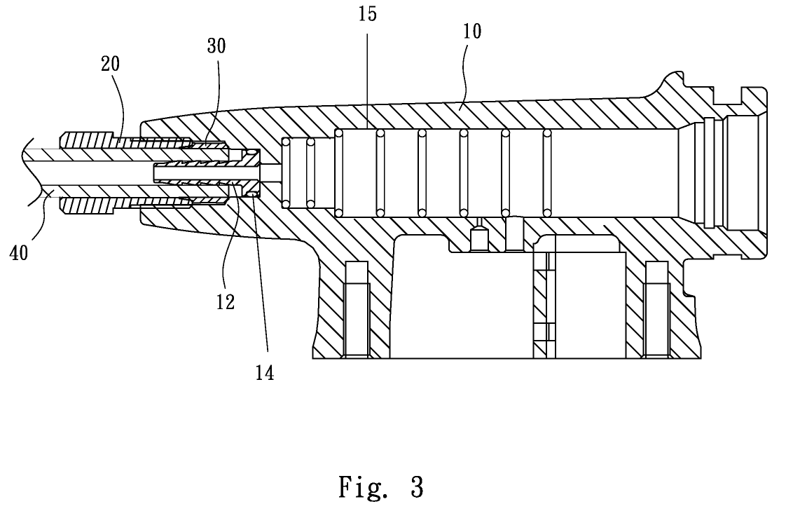

A brake fluid tube 40 is formed of plastic and is slidably disposed through the adjustment screw 20 (see FIG. 2) and even the cylindrical element 30 in one use state (see FIG. 3). As shown in FIG. 3, brake fluid may flow from the reservoir 15 to the tube 40 or from the tube 40 to the reservoir 15.

In an installation operation, a person may drive the adjustment screw 20 to compress the cylindrical element 30. Hence, the groove 31 is completely compressed by the shoulders 32. Thus, the shoulders 32 meet each other with the groove 31 disappeared when the adjustment screw 20 is driven to its limit (see FIG. 3). As such, surface of the channel 13 is substantially not compressed by the cylindrical element 30 and surface of the tube 40 only contacts the cylindrical element 30. The person thus can easily remove the tube 40 by pulling for replacement or repair.

While the invention herein disclosed has been described by means of specific embodiments, numerous modifications and variations could be made thereto by those skilled in the art without departing from the scope and spirit of the invention set forth in the claims.

What is claimed is:

1. A coupling for a hydraulic disc brake of a bicycle comprising, in combination:
a housing comprising a stepped-diameter channel having a threaded opening, and a hollow, staged cylindrical member having an inner end disposed at an innermost shoulder of the channel;
a hollow cylindrical element formed of metal and comprising an annular groove on an outer surface, and two annular shoulders with the groove formed therebetween wherein the cylindrical element has an inner end disposed at a shoulder adjacent to the innermost shoulder of the channel;
a hollow adjustment screw adapted to secure to the threaded opening; and
a brake fluid tube adapted to slidably dispose through the adjustment screw and the cylindrical element,
whereby driving the adjustment screw will compress the cylindrical element with the groove being completely compressed by the shoulders, a surface of the channel being substantially not compressed by the cylindrical element, and the brake fluid tube being in contact with the cylindrical element.

2. The coupling of claim 1, wherein the cylindrical element is formed of bronze.
